(19) United States
(12) Patent Application Publication
(10) Pub. No.: US 2024/0075393 A1
(43) Pub. Date: Mar. 7, 2024

(54) RECORDING MEDIUM AND INFORMATION PROCESSING DEVICE

(71) Applicant: SEGA CORPORATION, Tokyo (JP)

(72) Inventors: Yasuhiro Nishiyama, Tokyo (JP); Masahito Kurosawa, Tokyo (JP)

(73) Assignee: SEGA CORPORATION, Tokyo (JP)

(21) Appl. No.: 18/388,919

(22) Filed: Nov. 13, 2023

Related U.S. Application Data
(63) Continuation of application No. PCT/JP2022/019872, filed on May 10, 2022.

(30) Foreign Application Priority Data
May 13, 2021 (JP) 2021-081406

(51) Int. Cl. A63F 13/86

(52) U.S. Cl. CPC A63F 13/86

(57) ABSTRACT

A non-transitory computer readable recording medium stores instructions for an information processing device that comprises a processor, a display device, and an audio output device. The instructions cause the processor to execute: acquiring, from a distribution server, a game video; acquiring, from a management system, operation information regarding a player playing a game in the game video, and event information on an event having occurred in the game based on the operation information; combining the game video, the operation information, and the event information to generate a final video; and presenting the final video via the display device and the audio output device.

### BACKGROUND

### Technical Field

The present invention relates to a recording medium storing instructions and an information processing device.

### Description of Related Art

There is a conventional technique for distributing game video that shows what a game being played by a player is about and how it looks.

In relation to this, Patent Literature 1, for example, discloses that operation information for a player is added to the game video and displayed.

### PATENT LITERATURE

Patent Literature 1: Japanese Patent No. 6,098,691

However, with the gaming technology of Patent Literature 1, it is sometimes difficult for viewers to understand how a player's operations are related to the events caused by those operations, which can make the distributed game video less exciting.

### SUMMARY

One or more embodiments of the present invention provide a technological improvement over such conventional gaming technologies discussed above. In particular, one or more embodiments of the present invention provide an information processing device and a recording medium storing instructions that combine game video, operation information, and event information in a predetermined way to generate and present a final video to the viewers. As a result, it becomes possible to distribute the game video while showing a relation between the operation information and the event information having occurred based on the operation information, which enables clearer visualization of game contents.

According to a first mode of the present invention, there is provided a non-transitory computer readable recording medium storing instructions for a computer (e.g., an information processing device), the instructions causing the computer to function as: an acquisition unit (i.e., a processor) for acquiring, from a distribution server, a game video; acquiring, from a management system, operation information regarding a player playing a game in the game video, and event information on an event having occurred in the game based on the operation information; and a combination unit (i.e., the processor) for combining the game video, the operation information, and the event information acquired by the acquisition unit to generate a final video, wherein the final video is presented via a display device and an audio output device.

Also, with the non-transitory computer readable recording medium according to a second mode of the present invention, the combination unit combines the game video and the operation information such that the operation information can be viewed in chronological order.

Also, with the non-transitory computer readable recording medium according to a third mode of the present invention, the combination unit combines the game video, the operation information, and the event information such that the event information can be viewed in comparison with the operation information.

Also, with the non-transitory computer readable recording medium according to a fourth mode of the present invention, a character controlled by the player appears in the game video, and the event information includes action information regarding the character, and status information regarding the character.

Also, with the non-transitory computer readable recording medium according to a fifth mode of the present invention, in a case that a first player plays the game in the game video and that another character controlled by a second player appears in the game video, the combination unit combines the game video, operation information regarding the first player, and operation information regarding the second player such that the operation information regarding the second player can be viewed in comparison with the operation information regarding the first player during the second player is playing the game in the game video.

Also, the information processing device according to a sixth mode of the present invention comprises: a processor; a display device; and an audio output device, wherein the processor: acquires, from a distribution server, a game video, acquires, from a management system, operation information regarding a player playing a game in the game video, and event information on an event having occurred in the game based on the operation information, and combines the game video, the operation information, and the event information to generate a final video, and presents the final video via the display device and the audio output device.

With the above features, the game video, the operation information, and the event information can be combined in a predetermined way to generate and present a final video to the viewers. As a result, it becomes possible to distribute the game video while showing the relation between the operation information and the event information having occurred based on the operation information, which enables clearer visualization of game contents.

### BRIEF DESCRIPTION OF THE DRAWINGS

FIG. 1 is a block diagram that schematically shows an example of the overall configuration of the video distribution system according to a first embodiment of the present invention;

FIG. 2 is a block diagram that schematically shows an example of the hardware configuration of the first server shown in FIG. 1;

FIG. 3 is a block diagram that schematically shows an example of the hardware configuration of the viewer terminal shown in FIG. 1;

FIG. 4 is a block diagram that shows an example of the functional components of the viewer terminal shown in FIG. 1;

FIG. 5 is a diagram that schematically shows an example of the flow of the processing executed by the video distribution system according to the first embodiment of the present invention;

FIG. 6A is a diagram that shows an example of the basic game information acquired by the second acquisition unit;

FIG. 6B is a diagram that shows another example of the basic game information acquired by the second acquisition unit;

FIG. 7A is a diagram that shows an example of the distributor information acquired by the second acquisition unit;

FIG. 7B is a diagram that shows another example of the distributor information acquired by the second acquisition unit;

FIG. 8A is a diagram that shows an example of the content information acquired by the second acquisition unit;

FIG. 8B is a diagram that shows another example of the content information acquired by the second acquisition unit;

FIG. 9 is a diagram that shows an example of a final video; and

FIG. 10 is a diagram that schematically shows an example of the flow of the processing executed by the video distribution system according to a second embodiment of the present invention.

### DETAILED DESCRIPTION OF EMBODIMENTS

A number of embodiments of the present invention will now be described with reference to the appended drawings. To facilitate understanding of the description, components and steps that are the same will be numbered the same as much as possible in the drawings, and redundant description will be omitted.

### First Embodiment

First, the video distribution system according to a first embodiment of the present invention will be described.

Overall Configuration

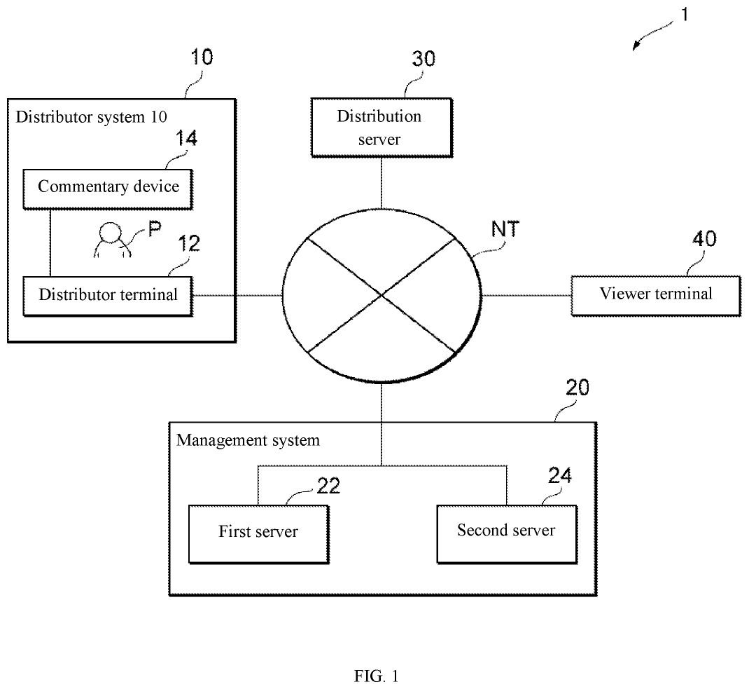

FIG. 1 is a block diagram that schematically shows an example of the overall configuration of the video distribution system according to a first embodiment of the present invention.

As shown in FIG. 1, a video distribution system 1 according to the first embodiment comprises one or more distributor systems 10, a management system 20, a distribution server 30, and one or more viewer terminals 40. These systems and terminals are configured to be able to communicate with each other over a communication network NT such as the Internet or a telephone line.

The distributor system 10 provides to the distribution server 30 a distributed game video obtained by combining game video of a game being played by a player P with a commentary video showing how the distributor is commenting and/or playing the game. There are no particular restrictions on the game, but examples include battle games, shooting games, race games, role playing games, puzzle games, adventure games, and music games. Also, content controlled by the player, particularly characters, may appear in the game video. Also, if we refer to player P as one player, other characters controlled by other players different from the one player may also appear in the game video.

The distributor system 10 described above comprises a distributor terminal 12 and a commentary device 14, for example. The distributor terminal 12 is a device that receives operations performed by the player P who is the distributor, executes the game, and generates the game video. Examples of the distributor terminal 12 include a personal computer, a game machine, an arcade game device, a smart phone, and a tablet. The commentary device 14 is constituted by a camera, a microphone, etc., and generates a commentary video showing how the distributor is commenting on the game and/or playing the game. In the first embodiment, a case in which the player P and the distributor (commentator) are the same person is described, but the player P and the distributor may be different people. When the player P and the distributor are different people, the distributor system 10 may be provided with a game terminal with which the game can be executed based on operations performed by the player P, in addition to the distributor terminal 12.

The management system 20 stores and manages various kinds of information about the game, the player P, etc. This management system 20 comprises a first server 22 and a second server 24, for example. The first server 22 receives from the distributor terminal 12 operation information for the player P on the distributor terminal 12 and event information about events that have occurred in the game based on that operation information, and stores this information. The second server 24 stores distributor information, player information, and content information as reference information. Examples of the operation information include information indicating that the right button on the controller (not shown) connected to the distributor terminal 12 was pressed, the upper button was pressed, the attack button was pressed, the technique button was pressed, etc. Event information includes character status information and action information about a character, such as when that character appears, or other such content controlled by the player P in the game video. Examples of action information include attacking, defending, skills, magic, special effects, movements, and jumps. Examples of character status information include a character being on the defense, or being confused, asleep, incapacitated, unconscious, or when a combo occurs. Examples of distributor information include the number of distributions by a distributor, distribution ranking, distribution history, distribution performance (including the number of viewers, etc.), age, name, nickname, sex, team affiliation, and contact information. Examples of player information include name, nickname, age, sex, team affiliation, contact information, habits, and interests. Also, player information may include game performance indicators such as game history, play time, tournament participation history, ranking, number of matches, past opponents, winning percentage, and the like. Also, content information includes the status of hit points, attack power, defense power, and the like, as well as extent of limit breakthrough, rarity, winning percentage, selection rate, ranking, special moves, equipment, organization, and the like.

The distribution server 30 is configured to be able to manage one or more distributed game videos and distribute them to the viewer terminals 40.

The viewer terminal 40 combines (adds) reference information for the viewer and the distributed game video from the distribution server 30, and outputs the combined video (hereinafter referred to as the “final video”) to the viewer. Examples of types of reference information include player information, distributor information, and basic game information. Examples of basic game information include the game title, match name, quest name, quest boss information, quest difficulty level, and tournament table.

Hardware Configuration

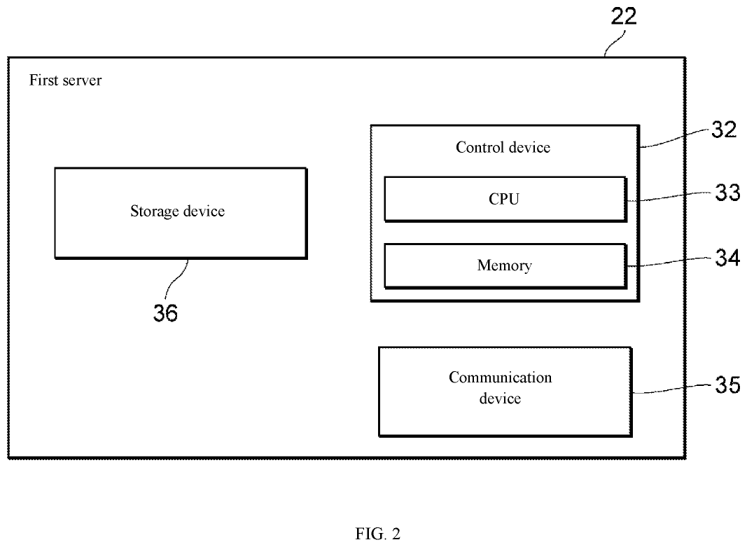

FIG. 2 is a block diagram that schematically shows an example of the hardware configuration of the first server 22 shown in FIG. 1. The hardware configuration of the second server 24 is the same as that of the first server 22.

As shown in FIG. 2, the first server 22 comprises a control board 32, a communication device 35, and a storage device 36. The control board 32 mainly comprises a CPU (central processing unit) 33 (processor) and a memory 34 (non-transitory computer readable recording medium).

In the control board 32, the CPU 33 functions as various functional components by executing specific programs or instructions stored in the memory 34, the storage device 36, or the like. These functional components will be described in detail below.

The communication device 35 is constituted by a communication interface or the like for communicating with an external device. The communication device 35 sends and receives various kinds of information to and from the distributor terminal 12, for example.

The storage device 36 is constituted by a hard disk or the like. The storage device 36 stores various kinds of programs or instructions and various kinds of information necessary for executing processing in the control board 32 as well as information about processing results.

The first server 22 can be realized by using an information processing device such as a dedicated or general-purpose server computer. Also, the first server 22 may be constituted by a single information processing device or by a plurality of information processing devices distributed on the communication network NT. Also, FIG. 2 shows only a part of the main hardware configuration of the first server 22, and the first server 22 can comprise other components that are ordinarily provided to a server.

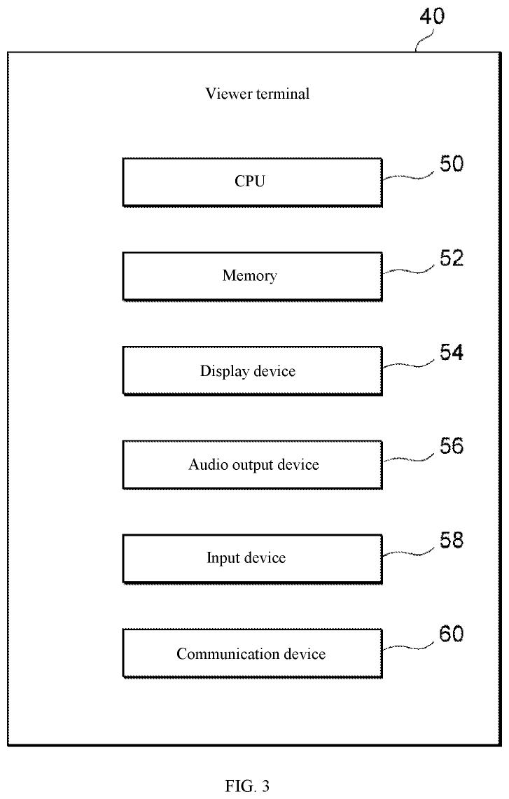

FIG. 3 is a block diagram that schematically shows an example of the hardware configuration of the viewer terminal 40 shown in FIG. 1.

As shown in FIG. 3, the hardware configuration of the viewer terminal 40 comprises a CPU (processor) 50, a memory (non-transitory computer readable recording medium) 52, a display device 54, an audio output device 56, an input device 58, and a communication device 60.

The CPU 50 controls the display device 54, the audio output device 56, and the like.

The memory 52 stores various kinds of data and programs or instructions.

The display device 54 displays images and videos.

The audio output device 56 outputs sound for the game video, etc.

The input device 58 is used to input the viewer's operation information to the viewer terminal 40.

The communication device 60 is constituted by a communication interface or the like for communicating with an external device. The communication device 60 sends and receives various kinds of information to and from the first server 22 and the second server 24, for example.

Functional Components

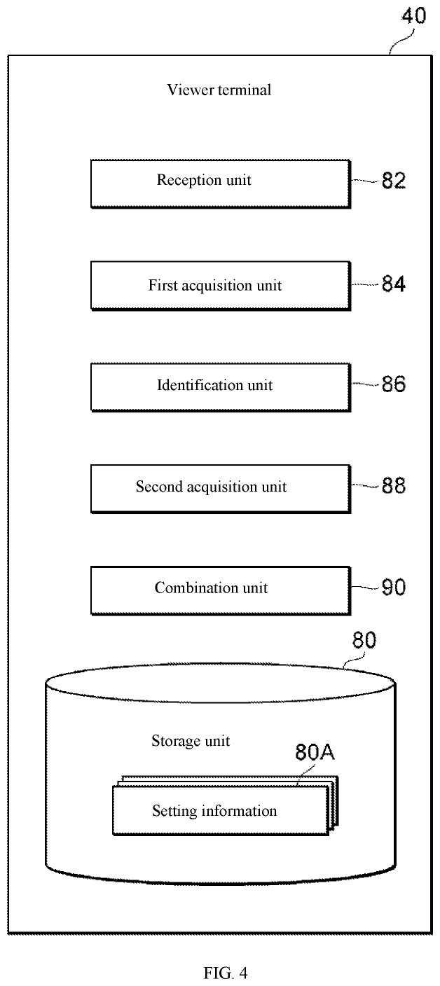

FIG. 4 is a block diagram that shows an example of the functional components of the viewer terminal 40 shown in FIG. 1.

As shown in FIG. 4, the functional components of the viewer terminal 40 comprise a storage unit (storage) 80, a reception unit 82, a first acquisition unit 84, an identification unit 86, a second acquisition unit 88, and a combination unit 90. These functional components are realized when the CPU 50 executes a program or instructions.

The storage unit 80 stores setting information 80A. The setting information 80A is information indicating the type of reference information preset by the distributor or the player P.

The reception unit 82 has a function of receiving the setting of the type of reference information from the distributor or the player P prior to the distribution of the game video.

The first acquisition unit 84 has a function of acquiring game video distributed over the communication network NT.

The identification unit 86 has a function of identifying a game related to the game video based on the game video acquired by the first acquisition unit 84, information from the management system 20, or the like. Also, the identification unit 86 may identify the distributor or the player P related to the game video based on the game video acquired by the first acquisition unit 84, information from the management system 20, or the like. The identification unit 86 may identify content that appears in the game video. Also, the identification unit 86 may identify the progress status of the game related to the game video.

The second acquisition unit 88 has a function of acquiring reference information for a viewer of the game video, such that different types of reference information are acquired depending on the game identified by the identification unit 86. Also, the second acquisition unit 88 may acquire, as reference information, different types of distributor information or player information depending on the distributor or the player P identified by the identification unit 86. In particular, the second acquisition unit 88 may acquire, as reference information, distributor information or player information of the type whose setting was received by the reception unit 82. Also, the second acquisition unit 88 may acquire, as reference information, different types of content information depending on the content identified by the identification unit 86. Also, the second acquisition unit 88 may acquire, as reference information, different types of content information depending on the progress status identified by the identification unit 86. Also, the second acquisition unit 88 may acquire, as reference information, distributor information of a distributor or player information of a player (in particular, performance information) related to the game video from the second server 24. Also, the second acquisition unit 88 may acquire, as reference information, operation information for the player P when the player P is playing the game related to the game video, and event information about events that have occurred in the game based on that operation information.

The combination unit 90 has a function of combining the game video acquired by the first acquisition unit 84 and the reference information acquired by the second acquisition unit 88. In other words, the combination unit 90 has a function of adding the reference information acquired by the second acquisition unit 88 to the game video acquired by the first acquisition unit 84. Also, the combination unit 90 may have a function of combining the game video, the operation information, and the event information acquired by the first acquisition unit 84. Also, the combination unit 90 combines the game video and the operation information so that the operation information can be viewed in chronological order. Also, the combination unit 90 may combine the game video, the operation information, and the event information so that the event information can be viewed in comparison with the operation information. Also, if another player is playing the game related to the game video, the combination unit 90 may combine the game video, operation information for one player, and operation information for the other player so that operation information for the other player can be viewed in comparison with the operation information for the one player.

Flow of Processing

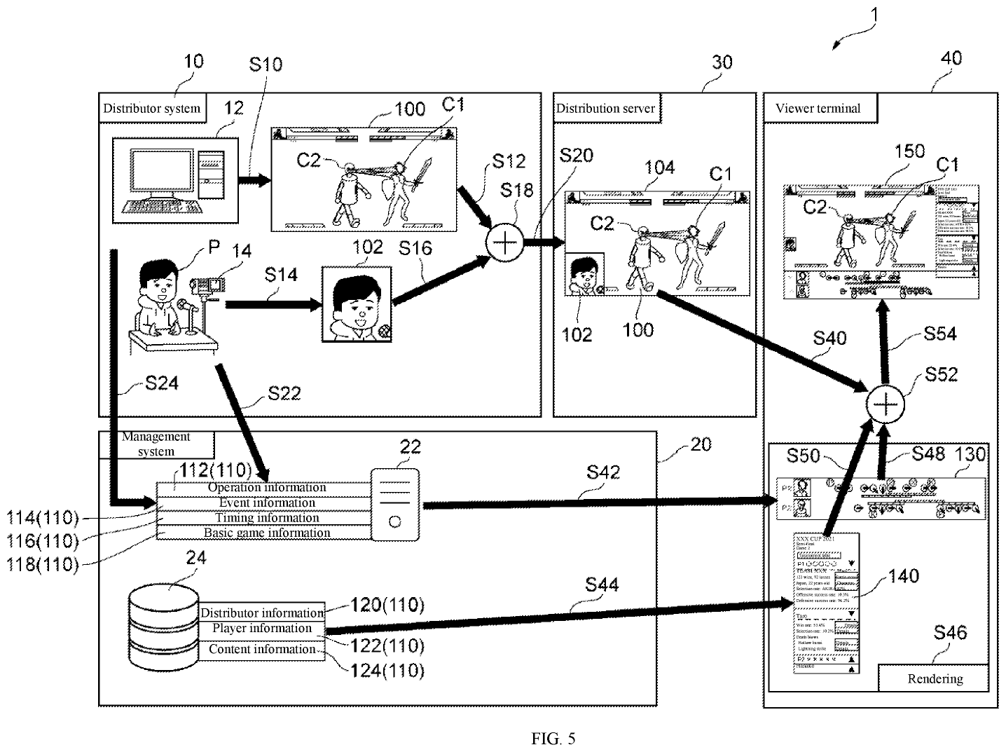

FIG. 5 is a diagram that schematically shows an example of the flow of processing executed by the video distribution system 1 according to the first embodiment of the present invention. The order and details of the processing in the following steps can be changed as needed.

(Step S10)

In the distributor system 10, the distributor terminal 12 executes a game based on operation information for the player P. As a result, the player P plays the game. Here, the distributor terminal 12 records (generates) a game video 100 of the game that the player P is playing. A character C1 controlled by one player P and a character C2 controlled by another player appear in this game video 100, for example. Then, the processing moves to the processing of step S12.

(Step S12)

The distributor terminal 12 stores the generated game video 100 in a combination area provided in its storage device as needed. Then, the processing moves to the processing of step S18.

(Step S14)

In parallel with the processing in step S10, the commentary device 14 records (generates) a picture-in-picture screen, that is, a commentary video 102, showing the player P giving live commentary about and/or playing the game. Then, the processing moves to the processing of step S16.

(Step S16)

The distributor terminal 12 stores the generated commentary video 102 in a combination area provided in its storage device as needed. Then, the processing moves to the processing of step S18.

(Step S18)

The distributor terminal 12 combines the game video 100 and the commentary video 102 stored in the combination area to generate a distributed game video 104 used for distribution. Then, the processing moves to the processing of step S20.

(Step S20)

The distributor terminal 12 transmits the generated distributed game video 104 to the distribution server 30. The distribution server 30 receives the distributed game video 104 from the distributor terminal 12. In response to this, the distribution server 30 stores the video in its storage device so that the video can be distributed to the viewer terminal 40, etc. Then, the processing moves to the processing of step S40.

(Step S22)

In parallel with the processing of steps S10 and S14, the distributor terminal 12 or the commentary device 14 transmits operation information 112 for the player P when the player P is playing the game related to the game video 100, as well as event information 114 about the events that have occurred in the game based on that operation information to the first server 22 of the management system 20. The first server 22 receives the operation information 112 and the event information 114 from the distributor terminal 12 or the commentary device 14, and stores the information. Then, the processing moves to the processing of step S40.

(Step S24)

The distributor terminal 12 transmits to the first server 22 timing information 116 indicating the timing of occurrence of the event information 114 in the game video 100, and basic game information 118 such as the game title name, character names, organization information, etc., related to the game video 100. The first server 22 receives the timing information 116 and the basic game information 118 from the distributor terminal 12, and stores the information. Then, the processing moves to the processing of step S40.

(Step S40)

The first acquisition unit 84 of the viewer terminal 40 acquires the distributed game video 104 distributed by the distribution server 30 in accordance with the manual or automatic selection made by the viewer, and stores this in the storage unit 80. Then, the identification unit 86 of the viewer terminal 40 identifies the game related to the distributed game video 104 acquired by the first acquisition unit 84, based on the information included in the distributed game video 104, the information provided from the distribution server 30, etc. Also, the identification unit 86 may perform image analysis on the distributed game video 104 to identify the game related to the distributed game video 104. Also, the identification unit 86 identifies the player P related to the distributed game video 104, the content (character C1 and character C2) appearing in the distributed game video 104, and the progress status of the game related to the distributed game video 104, based on the information included in the distributed game video 104, the information provided by the distribution server 30, the information stored in the second server 24, and the like. Then, the processing moves to the processing of step S42.

(Step S42)

The second acquisition unit 88 of the viewer terminal 40 acquires, as part of the reference information 110, the operation information 112 for the player P related to the game identified by the identification unit 86, the event information 114 about events that have occurred in the game based on that operation information 112, and the timing information 116, from the first server 22. Also, the second acquisition unit 88 acquires, as part of the reference information 110, different types of basic game information 118 depending on the game identified by the identification unit 86, from the first server 22.

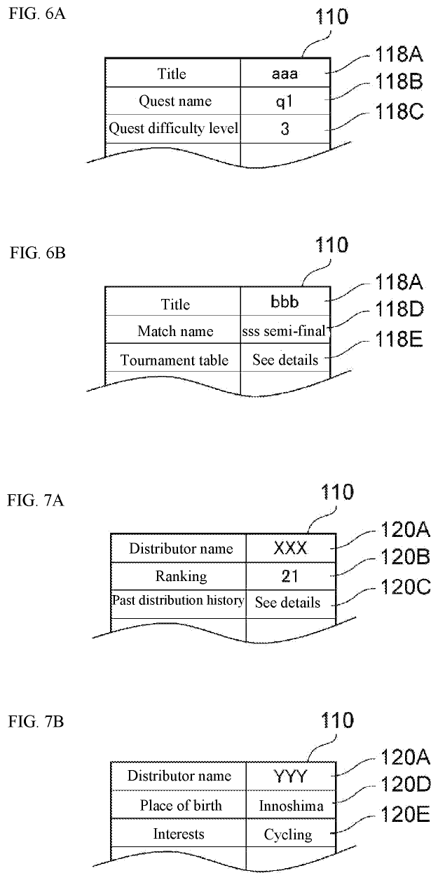

FIG. 6A is a diagram that shows an example of the basic game information 118 acquired by the second acquisition unit 88. FIG. 6B is a diagram that shows another example of the basic game information 118 acquired by the second acquisition unit 88.

As shown in FIG. 6A, if the game identified by the identification unit 86 has a title of “aaa,” the second acquisition unit 88 acquires from the first server 22, as basic game information 118, the quest name 118B and the quest difficulty level 118C, in addition to the title 118A, for the game “aaa.”

On the other hand, as shown in FIG. 6B, if the game identified by the identification unit 86 has a title of “bbb,” the second acquisition unit 88 acquires from the first server 22, in addition to the title 118A, the match name 118D and tournament table 118E for the game “bbb,” which is basic game information 118 different from that of the game “aaa.”

Going back to FIG. 5, the processing moves to the processing of step S44. The order of the processing in step S42 and step S44 may be reversed.

(Step S44)

The second acquisition unit 88 acquires, as part of the reference information 110, different types of distributor information 120 or player information 122 depending on the distributor or the player P identified by the identification unit 86, from the second server 24. Also, the second acquisition unit 88 may acquire the distributor information 120 or the player information 122 of the type indicated by the setting information 80A preset by the distributor or player P identified by the identification unit 86. Also, the second acquisition unit 88 acquires, as part of the reference information 110, different types of content information 124 depending on the content identified by the identification unit 86, from the second server 24. Also, the second acquisition unit 88 acquires, as part of the reference information 110, different types of content information 124 depending on the progress status identified by the identification unit 86, from the second server 24.

FIG. 7A is a diagram that shows an example of the distributor information 120 acquired by the second acquisition unit 88. FIG. 7B is a diagram that shows another example of the distributor information 120 acquired by the second acquisition unit 88.

As shown in FIG. 7A, if the distributor identified by the identification unit 86 has a distributor name of “XXX,” the second acquisition unit 88 acquires from the second server 24, as distributor information 120, the ranking 120B and the past distribution history 120C, in addition to the distributor name 120A, for the distributor “XXX.”

On the other hand, as shown in FIG. 7B, if the distributor identified by the identification unit 86 has a distributor name of “YYY,” the second acquisition unit 88 acquires from the second server 24, in addition to the distributor name 120A, the place of birth 120D and interests 120E for the distributor “YYY,” which is distributor information 120 different from that of the distributor “XXX.”

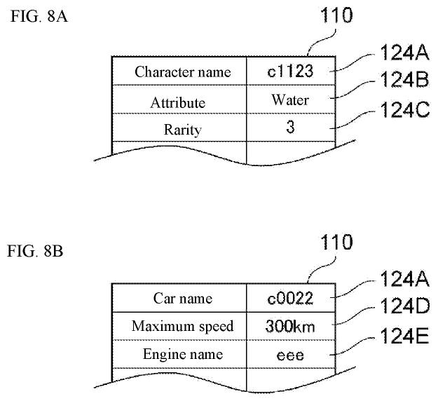

FIG. 8A is a diagram that shows an example of the content information 124 acquired by the second acquisition unit 88. FIG. 8B is a diagram that shows another example of the content information 124 acquired by the second acquisition unit 88.

As shown in FIG. 8A, if the content identified by the identification unit 86 has a content name (character name) of “c1123,” the second acquisition unit 88 acquires from the second server 24, as content information 124, the attribute 124B and the rarity 124C, in addition to the content name 124A, for the content “c1123.”

On the other hand, as shown in FIG. 8B, if the content identified by the identification unit 86 has a content name (car name) of “c0022,” the second acquisition unit 88 acquires from the second server 24, in addition to the content name 124A, the maximum speed 124D and the engine name 124E for the content “c0022,” which is content information 124 different from that of the content “c1123.”

Going back to FIG. 5, the processing moves to the processing of step S46.

(Step S46)

The combination unit 90 of the viewer terminal 40 renders an operation reference image 130 based on the operation information 112, the event information 114, and the timing information 116 acquired by the second acquisition unit 88, such that the operation information 112 can be viewed in chronological order, and such that the event information 114 can be viewed in comparison with the operation information 112. Here, if another player is playing the game related to the distributed game video 104, the combination unit 90 renders such that the operation information for the other player can be viewed in a state that affords comparison with the operation information 112 for the one player P.

Also, the combination unit 90 renders a reference menu image 140 based on the reference information 110 including the basic game information 118, the distributor information 120, the player information 122, and the content information 124 acquired by the second acquisition unit 88, such that all this information can be viewed. Then, the processing moves to the processing of step S48.

(Step S48)

The combination unit 90 stores the operation reference image 130 obtained by the rendering in the combination area of the storage unit 80. Then, the processing moves to the processing of step S50.

(Step S50)

The combination unit 90 stores the reference menu image 140 obtained by the rendering in the combination area of the storage unit 80. Then, the processing moves to the processing of step S52.

(Step S52)

The combination unit 90 generates a final video 150 by combining the distributed game video 104 acquired by the first acquisition unit 84, the operation reference image 130, and the reference menu image 140 stored in the combination area, based on the timing information 116. Then, the processing moves to the processing of step S54.

(Step S54)

The combination unit 90 outputs the final video 150 thus generated to the display device 54 or the audio output device 56.

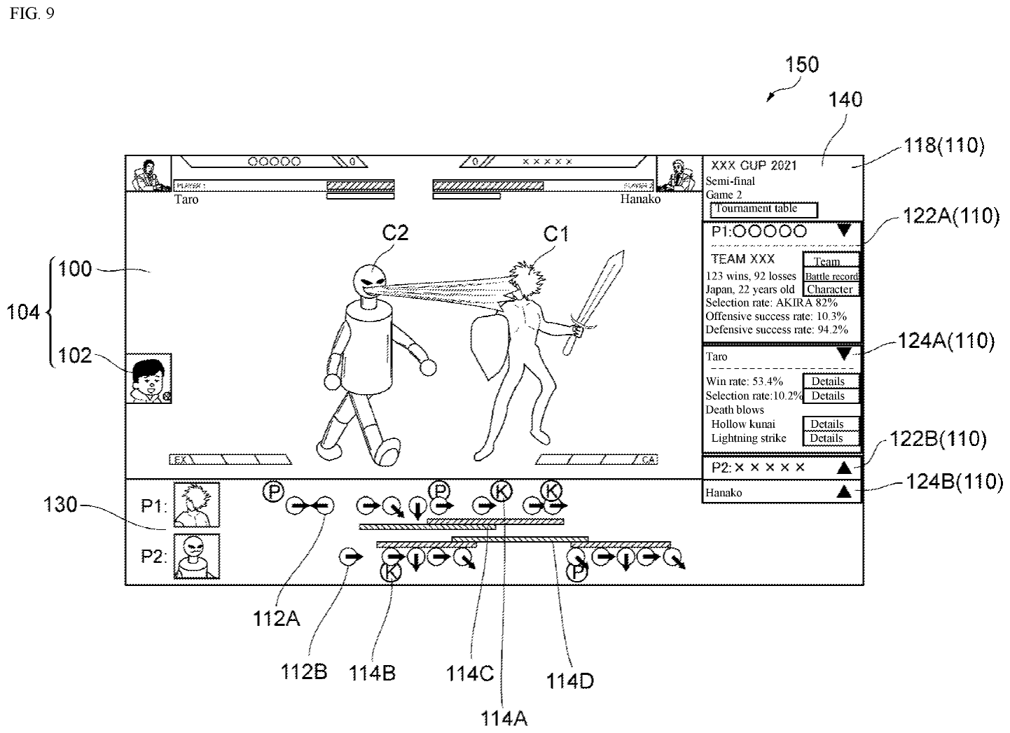

FIG. 9 is a diagram that shows an example of the final video 150.

As shown in FIG. 9, the final video 150 includes the operation reference image 130 and the reference menu image 140 in addition to the distributed game video 104 in which game video 100 and commentary video 102 are combined.

With the operation reference image 130, the operation information 112A for one player P and the operation information 112B for the other player can be viewed in chronological order by the viewer as the operation information 112. Also, with the operation reference image 130, the action information 114A for the character C1, the action information 114B for the character C2, the status information 114C for the character C1, and the status information 114D for the character C2 can be viewed in chronological order by the viewer as the event information 114. All of this information forms a part of the reference information 110 for the viewer. The status information 114C and the status information 114D shown in FIG. 9 are displayed as bars so that it can also be ascertained how long an attack determination or a stun determination have been continuing.

The reference menu image 140, as part of the reference information 110, includes the basic game information 118, the player information 122A for the one player P, the content information 124 for the character C1 controlled by the one player P, the player information 122B for another player, and the content information 124 for the character C2 controlled by the other player.

In the first embodiment above, a program or instructions cause the viewer terminal 40 (serving as a computer) to function as: the first acquisition unit 84 for acquiring the distributed game video 104; the identification unit 86 for identifying a game related to the game video 104 acquired by the first acquisition unit 84; the second acquisition unit 88 for acquiring reference information 110 for a viewer of the game video 104, such that different types of reference information are acquired depending on the game identified by the identification unit 86; and the combination unit 90 for combining the distributed game video 104 acquired by the first acquisition unit 84 and the reference information 110 acquired by the second acquisition unit 88.

With this configuration, different types of reference information 110 are outputted along with the distributed game video 104 depending on the game, so that the type of reference information 110 that will be useful to the viewer is outputted. As a result, it becomes possible to distribute the game video while showing a relation between the operation information and the event information having occurred based on the operation information, which enables clearer visualization of game contents.

Also, in the first embodiment, the identification unit 86 identifies the distributor or the player P related to the distributed game video 104, and the second acquisition unit 88 acquires, as reference information 110, different types of distributor information 120 or player information 122 depending on the distributor or the player P identified by the identification unit 86.

With this configuration, the type of distributor information 120 or player information 122 that will be useful to the viewer is outputted, which enables clearer visualization of game contents, thereby allows the distributed game video 104 to be made more exciting.

Also, in the first embodiment, the program or instructions cause the viewer terminal 40 to further function as the reception unit 82 for receiving the setting of the type of the reference information 110 from the distributor or the player P prior to the distribution of the distributed game video 104, and the second acquisition unit 88 acquires, as reference information 110, the distributor information 120 or the player information 122 of the type whose setting was received by the reception unit 82.

With this configuration, the type of distributor information 120 or player information 122 that is appealing to the distributor or player P is outputted, which enables clearer visualization of game contents, thereby allows the distributed game video 104 to be made more exciting and improves the level of satisfaction of the distributor or player P.

Also, in the first embodiment, the identification unit 86 identifies content appearing in the distributed game video 104, and the second acquisition unit 88 acquires, as reference information 110, different types of content information 124 depending on the content identified by the identification unit 86.

With this configuration, the type of content information 124 that will be useful to the viewer is outputted, which enables clearer visualization of game contents, thereby allows the distributed game video 104 to be made more exciting.

Also, in the first embodiment, the identification unit 86 identifies the progress status of the game related to the distributed game video 104, and the second acquisition unit 88 acquires, as reference information 110, different types of content information 124 depending on the progress status identified by the identification unit 86.

With this configuration, the type of content information 124 that will be useful to the viewer is outputted, depending on the progress status of the game, which enables clearer visualization of game contents, thereby allows the distributed game video 104 to be made more exciting.

Also, in the first embodiment, the program or instructions cause the viewer terminal 40 (serving as a computer) to function as the second acquisition unit 88 for acquiring the distributed game video 104, the operation information 112 for the player P when the player P is playing the game related to the distributed game video 104, the event information 114 about events that have occurred in the game based on that operation information 112, and the combination unit 90 for combining the distributed game video 104, the operation information 112, and the event information 114 acquired by the second acquisition unit 88.

With this configuration, not only the operation information 112 but also the event information 114 about the events that have occurred in the game based on that operation information 112 is outputted, so the viewer can immediately visually confirm the relevance between an operation performed by the player P and the event caused by that operation, such as which event will occur and how accurately it will occur when a certain operation is made, or how quickly a reaction to an attack occurs, which enables clearer visualization of game contents. As a result, the viewer can grasp at a glance the operation habits, personality, play details, etc., of the player P, thereby allowing the distributed game video 104 to be made more exciting.

Also, in the first embodiment, the combination unit 90 combines the distributed game video 104 and the operation information 112 so that the operation information 112 can be viewed in chronological order.

With this configuration, the viewer can view the operation information 112 in chronological order, which will serve as a reference for future play to the viewer. This enables clearer visualization of game contents, thereby allows the distributed game video 104 to be made even more exciting.

Also, in the first embodiment, the combination unit 90 combines the distributed game video 104, the operation information 112, and the event information 114 so that the event information 114 can be viewed in comparison with the operation information 112.

With this configuration, the event information 114, which serves as a reference for future play to the viewer, can be viewed in comparison with the operation information 112. This enables clearer visualization of game contents, thereby allows the distributed game video 104 to be made even more exciting.

Also, in the first embodiment, the character C1 controlled by the player P appears in the distributed game video 104, and the event information 114 includes action information for the character C1 and status information for the character C1.

With this configuration, the action information and status information, which serves as a reference for future play to the viewer, can be viewed. This enables clearer visualization of game contents, thereby allows the distributed game video 104 to be made even more exciting.

Also, in the first embodiment, if we refer to player P as one player, and another character C2 controlled by another player different from the one player P appears in the distributed game video 104, when the other player is playing the game related to the game video 104, the combination unit 90 combines the distributed game video 104, the operation information 112A for the one player, and the operation information 112B for the other player, so that the operation information 112B for the other player can be viewed in comparison with the operation information 112A for the one player.

With this configuration, the viewer can view the operation information 112A for the one player and the operation information 112B for the other player together. This enables clearer visualization of game contents, thereby allows the distributed game video 104 to be made even more exciting.

### Second Embodiment

Next, the video distribution system according to the second embodiment of the present invention will be described. The second embodiment differs from the first embodiment in that it is not the viewer terminal 40 but the management system 20 that performs rendering and combination processing. That is, the first server 22 and/or the second server 24 of the management system 20 comprises the storage unit 80, the reception unit 82, the first acquisition unit 84, the identification unit 86, the second acquisition unit 88, and the combination unit 90, which are the functional components shown in FIG. 4. A case will now be described in which the first server 22 has the above functional components.

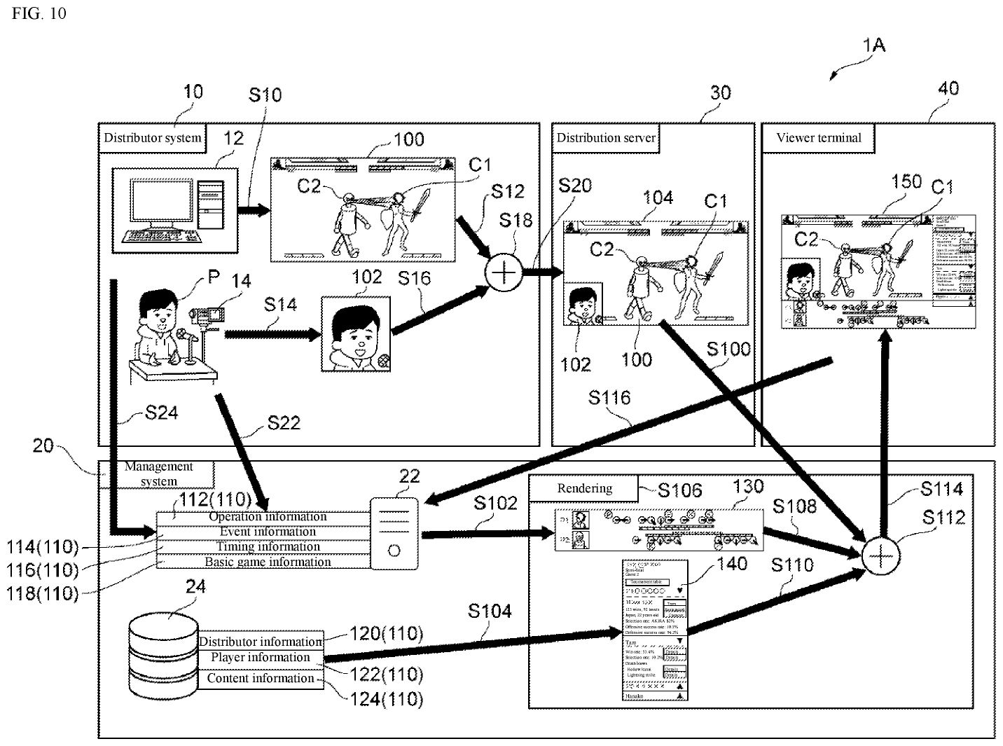

FIG. 10 is a diagram that schematically shows an example of the flow of processing executed by the video distribution system 1A according to the second embodiment of the invention. The order and details of the processing in the following steps can be changed as needed.

(Step S100)

The first acquisition unit 84 of the first server 22, for example, of the management system 20 acquires the distributed game video 104 distributed by the distribution server 30 in accordance with the manual or automatic selection made by the viewer, and stores this in the storage unit 80. Then, the identification unit 86 of the first server 22 identifies the game related to the distributed game video 104 acquired by the first acquisition unit 84 based on the information included in the distributed game video 104, the information provided from the distribution server 30, etc. Also, the identification unit 86 identifies the player P related to the distributed game video 104, the content appearing in the distributed game video 104, and the progress status of the game related to the distributed game video 104, based on the information included in the distributed game video 104, the information provided by the distribution server 30, the information stored in the second server 24, and the like. Then, the processing moves to the processing of step S102.

(Step S102)

The second acquisition unit 88 of the first server 22 acquires, as part of the reference information 110, the operation information 112 for the player P related to the game identified by the identification unit 86, the event information 114 about events that have occurred in the game based on that operation information 112, and the timing information 116, from the storage unit 80 of the first server 22. Also, the second acquisition unit 88 acquires, as part of the reference information 110, different types of basic game information 118 depending on the game identified by the identification unit 86, from the storage unit 80 of the first server 22. Then, the processing moves to the processing of step S104.

(Step S104)

The second acquisition unit 88 acquires, as part of the reference information 110, different types of distributor information 120 or player information 122 depending on the distributor or the player P identified by the identification unit 86, from the second server 24. Also, the second acquisition unit 88 may acquire the distributor information 120 or the player information 122 of the type indicated by the setting information 80A preset by the distributor or player P identified by the identification unit 86. Also, the second acquisition unit 88 acquires, as part of the reference information 110, different types of content information 124 depending on the content identified by the identification unit 86, from the second server 24. Also, the second acquisition unit 88 acquires, as part of the reference information 110, different types of content information 124 depending on the progress status identified by the identification unit 86, from the second server 24. Then, the processing moves to the processing of step S106.

(Step S106)

The combination unit 90 of the first server 22 renders an operation reference image 130 based on the operation information 112, the event information 114, and the timing information 116 acquired by the second acquisition unit 88, such that the operation information 112 can be viewed in chronological order, and such that the event information 114 can be viewed in comparison with the operation information 112. Here, if another player is playing the game related to the distributed game video 104, the combination unit 90 renders an operation reference image 130 such that the operation information for the other player can be viewed in a state that affords comparison with the operation information 112 for the one player P.

Also, the combination unit 90 renders a reference menu image 140 based on the reference information 110 including the basic game information 118, the distributor information 120, the player information 122, and the content information 124 acquired by the second acquisition unit 88, such that all this information can be viewed. Then, the processing moves to the processing of step S108.

(Step S108)

The combination unit 90 stores the operation reference image 130 obtained by the rendering in the combination area of the storage unit 80. Then, the processing moves to the processing of step S110.

(Step S110)

The combination unit 90 stores the reference menu image 140 obtained by the rendering in the combination area of the storage unit 80. Then, the processing moves to the processing of step S112.

(Step S112)

The combination unit 90 generates a final video 150 by combining the distributed game video 104 acquired by the first acquisition unit 84, the operation reference image 130, and the reference menu image 140 stored in the combination area, based on the timing information 116. Then, the processing moves to the processing of step S114.

(Step S114)

The combination unit 90 transmits the final video 150 thus generated to the viewer terminal 40. The viewer terminal 40 receives the final video 150 from the first server 22. In response to this, the viewer terminal 40 outputs the received final video 150 to the display device 54 or the audio output device 56. Then, the processing moves to the processing of step S116.

(Step S116)

Upon receiving the viewer's selection of the reference information 110 displayed in the reference menu image 140 in the final video 150, the reception unit 82 transmits the received selection information to the first server 22 or the second server 24. The first server 22 or the second server 24 receives the selection information from the viewer terminal 40. In response to this, the first server 22 or the second server 24 acquires detailed information about the reference information 110 indicated by the received selection information. Then, the viewer terminal 40 repeats the processing of steps S102 to S114 so that the detailed information about the reference information 110 can be viewed.

In the second embodiment above, even if the performance of the viewer terminal 40 is poor and processing such as rendering and combination on the viewer terminal 40 is difficult, the management system 20 will perform processing such as rendering and combination, which allows the final video 150 to be smoothly outputted to the viewer terminal 40.

### Modifications

The present invention is not limited to or by the above embodiments. That is, suitable design changes made to the above embodiments by a person skilled in the art are also encompassed by the scope of the present invention as long as they still have the features of the present invention. Also, the elements of the embodiments above and the modified examples (discussed below) can be combined to an extent that is technically possible, and these combinations are also encompassed by the scope of the present invention as long as they still have the features of the present invention.

For example, in the first embodiment above, a case in which the first acquisition unit 84 acquired the distributed game video 104 was described, but a game video 100 from before the commentary video 102 has been combined may be acquired.

Also, in the first embodiment above, a case in which the distributor terminal 12 and the commentary device 14 were separate was described, but the distributor terminal 12 may have the function of the commentary device 14.

Also, in the first embodiment above, a case in which the combination unit 90 combined the distributed game video 104, the operation information 112, and the event information 114 was described, but the personality, play details, play style, player level (skill level), operation habits, technique generation history, technique generation ranking, and so forth of the player P may be analyzed based on the operation information 112 and the event information 114. In this case, the combination unit 90 may also combine these analysis results with the distributed game video 104.

Also, in the first embodiment, a case in which the final video 150 included the reference menu image 140 was described, but the reference menu image 140 need not be included. In this case, when the viewer selects a desired object (character C1, etc.) from the reference information 110 in the final video 150, an image of the reference information 110 indicated by this selected information is rendered and combined with the final video 150.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

22: first server (information processing device, computer), 40: viewer terminal (information processing device, computer), 88: second acquisition unit, 90: combination unit

What is claimed is:

1. A non-transitory computer readable recording medium storing instructions for an information processing device that comprises a processor, a display device, and an audio output device, the instructions causing the processor to execute:
acquiring, from a distribution server, a game video;
acquiring, from a management system, operation information regarding a player playing a game in the game video, and event information on an event having occurred in the game based on the operation information;
combining the game video, the operation information, and the event information to generate a final video; and
presenting the final video via the display device and the audio output device.

2. The non-transitory computer readable recording medium according to claim 1, wherein
the processor further:
combines the game video and the operation information such that the operation information can be viewed in chronological order.

3. The non-transitory computer readable recording medium according to claim 2, wherein
the processor further:
combines the game video, the operation information, and the event information such that the event information can be viewed in comparison with the operation information.

4. The non-transitory computer readable recording medium according to claim 3, wherein
a character controlled by the player appears in the game video, and
the event information includes action information regarding the character, and status information regarding the character.

5. The non-transitory computer readable recording medium according to claim 4, wherein
in a case that a first player plays the game in the game video and that another character controlled by a second player appears in the game video,
the processor combines the game video, operation information regarding the first player, and operation information regarding the second player such that the operation information regarding the second player can be viewed in comparison with the operation information regarding the first player during the second player is playing the game in the game video.

6. An information processing device, comprising:
a processor;
a display device; and
an audio output device, wherein
the processor:
acquires, from a distribution server, a game video,
acquires, from a management system, operation information regarding a player playing a game in the game video, and event information on an event having occurred in the game based on the operation information,
combines the game video, the operation information, and the event information to generate a final video, and
presents the final video via the display device and the audio output device.
